(19) United States
(12) Patent Application Publication
(10) Pub. No.: US 2002/0087690 A1
(43) Pub. Date: Jul. 4, 2002

(54) Automated content publishing

(75) Inventors: Stefan Alfons Hepper, Tuebingen (DE); Klaus Rindtorff, Weil im Schoenbuch (DE); Thomas Schaeck, Achern (DE)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY

(21) Appl. No.: 10/016,995

(22) Filed: Dec. 14, 2001

(30) Foreign Application Priority Data
Dec. 23, 2000 (EP) 00128497.5

(51) Int. Cl. G06F 15/173

(52) U.S. Cl. 709/225; 709/229

(57) ABSTRACT

Methods and systems of operating a computer system are provided. An example embodiment of the computer system comprises at least one content provider which is coupled to a portal which may also be coupled to a user. An example embodiment of the method comprises the following steps: the content provider offers a new content to the portal, the portal compares credentials of the content provider with stored credentials of registered content providers, and the portal accepts or rejects the content provider. Generally, the portal checks new content and accepts or rejects the new content.

### FIELD OF THE INVENTION

The invention relates to a method of operating a computer system as well as to a computer system comprising at least one content provider which is coupled to a portal which may be coupled to a user.

### BACKGROUND OF THE INVENTION

If a new content provider wants to offer a new content to a portal or if a known content provider wants to offer a new feed or channel to the portal, then it is necessary that the portal examines the new content provider or the new feed or channel. In known computer systems, this examination is performed manually, i.e. by an administrator who is a real person and who checks the new content provider or the new feed or channel and who then accepts or rejects the new content provider or the new feed or channel. Apparently, this procedure requires a lot of manual effort.

### SUMMARY OF THE INVENTION

It is therefore an aspect of the invention to provide a method of operating the computer system which requires less effort for allowing the new content provider to offer the new content to the portal and for allowing the known content provider to offer the new feed or channel to the portal.

The invention provides an automated method of registering a new content provider. As well, a new feed or channel of a known content provider may be registered automatically. For that purpose, the portal comprises a database for storing credentials of registered content providers. The portal then compares the credentials of the new content provider with the credentials of the registered content providers. If the new content provider is found in the database, the new content provider is allowed to offer new content to the portal.

### BRIEF DESCRIPTION OF THE DRAWINGS

These and other objects, features, and advantages of the present invention will become apparent upon further consideration of the following detailed description of the invention when read in conjunction with the following drawing figures, in which:

FIG. 1 shows an example computer system in accordance with the invention; and

FIG. 2 shows an example of a schematic block diagram of a method of operating the computer system of FIG. 1 ,in accordance with the invention.

### DETAILED DESCRIPTION OF THE INVENTION

The present invention provides methods, systems and apparatus for operating a computer system requiring less effort in allowing a new content provider to offer content to a portal, and/or for allowing a known content provider to offer a new feed or channel to the portal with old and/or new content.

The invention also provides an automated method of registering the new content provide, and provides for a new feed or channel of a known content provider to be registered manually and/or automatically. In an example embodiment, the portal includes a database for storing credentials of registered content providers. The portal then compares the credentials of the new content provider with the credentials of the registered content providers. If the new content provider is found in the database, the new content provider is allowed to offer new content to the portal. If there is no match, the portal examines the credentials of the new content provider. This evaluation may be performed fully automatically by an intelligent program with a rule database. Alternatively or additionally, the evaluation may be done semi- automatically by an administrator who is a real person. Depending on the evaluation, the portal accepts or rejects the new content provider. A similar procedure may be performed for a new feed or channel of a known content provider.

A similar procedure may be performed with respect to the new content which is offered by the new content provider or on the new feed or channel. In this situation, the new content may be evaluated fully automatically by an intelligent program again or semi-automatically by an administrator.

Furthermore, it is possible that the portal learns the preferences of the user from what the user selects and declines. Depending on these preferences, it is possible to notify the new content or the new feed or channel automatically to the user.

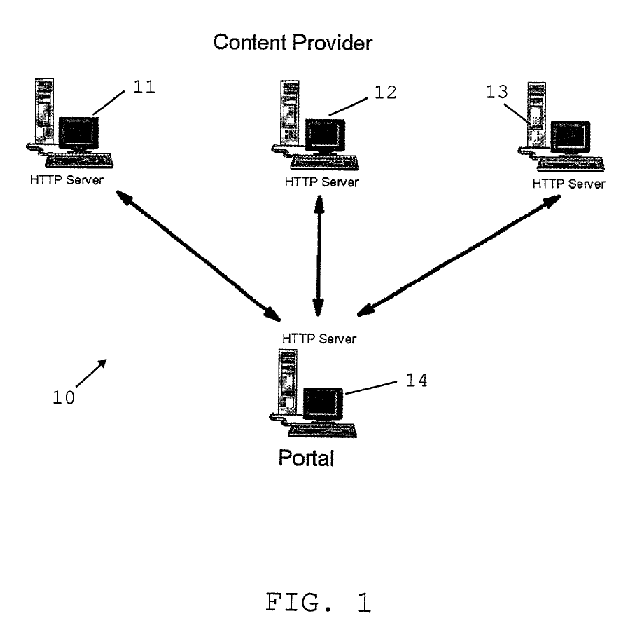

FIG. 1 shows a computer system 10 comprising a number of content providers 11, 12, 13 and a portal 14. The content providers 11, 12, 13 provide any kind of content like news, whether, stock quotes and so on. The portal 14 collects this content from the content providers 11, 12, 13 in order to forward the collected content to a requesting user. The content providers 11, 12, 13 and the portal 14 are located on server computers which run under the Hypertext Transmission Protocol (HTTP) so that the content providers 11, 12, 13 and the portal 14 may therefore connect to each other via the Internet.

It is now assumed that the content provider 13 is a new content source for the portal 14, i.e. is not yet known to the portal 14. In order to offer this new content source to the users, the portal 14 must first register the new content provider 13 and must then check the content provided by the new content provider 13.

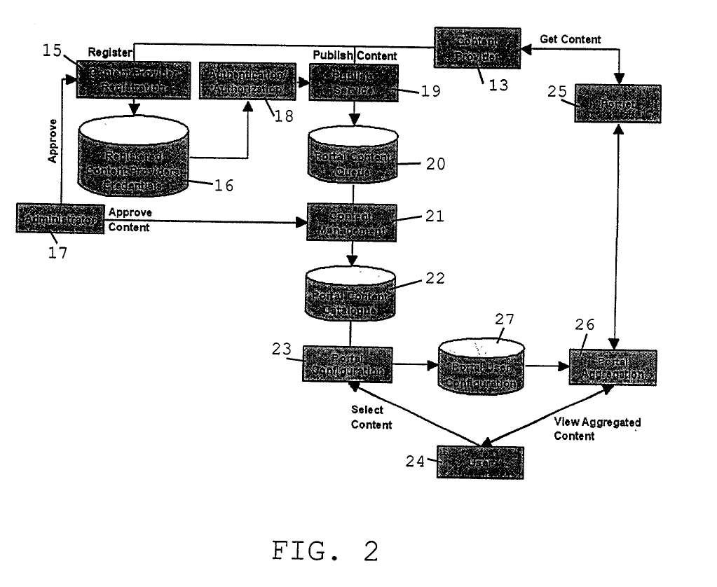

FIG. 2 shows a method for registering the new content provider 13 and for checking the content provided by the new content provider 13. For that purpose, the new content provider 13 is shown in FIG. 2.

The new content provider 13 may find the portal 14 e.g. with the help of the Universal Description, Discovery and Integration (UDDI) interface which the portal 14 provides in the Internet. From this UDDI interface, the new content provider 13 may collect all necessary information on how to contact the portal 14.

Then, the new content provider 13 contacts a content provider registration 15 at the portal 14 and sends its credentials to the portal 14. The credentials of the new content provider 13 are compared to the credentials of the registered content providers which are stored in a database 16 in the portal 14. As the new content provider 13 is not known to the portal 14, no corresponding credentials can be found. Therefore, an administrator 17 has to approve the new content provider 13.

The aforementioned administrator 17 can be a real person who checks the credentials of the new content provider 13 and then accepts or rejects the new content provider 13. As well, the administrator 17 can be an intelligent program with a rule database which automatically checks the credentials of the new content provider 13 and establishes a decision whether to accept or reject the new content provider 13. Of course, the last-mentioned fully automated version can additionally be accomplished by a real person.

If the new content provider 13 is approved by the administrator 17, the credentials of the new content provider 13 are stored in the database 16 of the registered content providers credentials. Furthermore, an authentication and authorization 18 is given to the new content provider 13 to provide its content to the portal 14.

It should be added that the subsequently described procedure is also applicable if the content provider 13 would not be new, but would be known to the portal 14.

With the help of a publish service 19 of the portal 14, the content provider 13 sends information to the portal 14 concerning the new content which the content provider 13 can offer and which therefore can be published by the portal 14. This information is stored in a portal content queue 20 in the portal 14.

The administrator 17 then checks the information stored in the portal content queue 20 and accepts or rejects the new content offered by the content provider 13. This evaluation of the new content is performed within a content management 21 in the portal 14. The accepted new content of the content provider 13 is then stored in a portal content catalogue 22. Furthermore, a message of the decision of the administrator 17 is sent to the content provider 13. It is noted that the administrator 17 can be a real person in a semi-automated version and/or an intelligent program in a fully automated version.

The entire available content of the portal 14 is then assembled into a portal configuration 23. A user 24 may then select any desired content from this portal configuration 23. The selected content is requested by the user 24 from the content provider 13 which sends the requested content with the help of a portlet 25 as a portal aggregation 26 to the user 24. The user 24 may then view the requested portal aggregation 26 on his/her computer system. The communication between the user 24 and the portal 14 may be performed via the Internet so that a known browser is sufficient for the user 24 to view the content received from the portal 14.

Alternatively or additionally, a notification service may be established within the portal 14. For that purpose, a database 27 may be built up which learns the preferences of the user 24 from what the user 24 selects and declines. If the new content of the content provider 13 is added to the portal configuration 23, a message may be sent to the user 24 if this new content matches with the preferences of the user 24. The user 24 may then access the new content without having to find and select the new content in the portal configuration 23.

The same method may be used for introducing a new feed or channel of a known content provider 11, 12, 13 into the portal content catalogue 23 and the portal configuration 24. For this purpose, the database 16 may comprise further credentials concerning the feeds or channels of the content providers 11, 12, 13. The credentials of any new feed or channel is then added to the database 16.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention.

The described embodiments ought to be construed to be merely illustrative of some of the more prominent features and applications of the invention. Other beneficial results can be realized by applying the disclosed invention in a different manner or modifying the invention in ways known to those familiar with the art.

What is claimed, is:

1. A method for operating a computer system comprising:
having at least one content provider coupled via a portal which may also be coupled to a user;
said at least one content provider offering a new content to the portal;
the portal comparing credentials of said at least one content provider with stored credentials of registered content providers; and
the portal accepting or rejecting at least a particular provider included in said at least one content provider based on said stored credentials.

2. A method as recited in claim 1, further comprising offering said credentials of said at least one content provider to the portal together with the new content.

3. A method as recited in claim 1, further comprising storing said credentials of the registered content providers in a database of the portal.

4. A method as recited in claim 1, further comprising performing automatically said comparison of the credentials with an intelligent program having a rule database.

5. A method as recited in claim 1, further comprising performing manually said comparison of the credentials.

6. A method as recited in claim 1, further comprising the portal checking the new content, and the portal accepting or rejecting the new content.

7. A method as recited in claim 6 wherein the evaluation of the new content is performed semi-automatically or fully automatically.

8. A method as recited in claim 6 wherein the user is notified about the new content if the new content matches with preferences of the user.

9. An article of manufacture comprising a computer usable medium having computer readable program code means embodied therein for causing operation of a computer system, the computer readable program code means in said article of manufacture comprising computer readable program code means for causing a computer to effect the steps of claim 1.

10. A computer system comprising at least one content provider which is coupled to a portal which may be coupled to a user wherein said at least one content provider comprises means for offering a new content to the portal, wherein the portal comprises means for comparing credentials of said at least one content provider with stored credentials of registered content providers, and wherein the portal comprises means for accepting or rejecting said at least one content provider.

11. The computer system of claim 10 wherein the portal comprises a database for registered content provider credentials.

12. A computer system as recited in claim 10 wherein said at least one content providers, the portal and the user are coupled via the Internet.

13. A program storage device readable by machine, tangibly embodying a program of instructions executable by the machine to perform method steps for causing operation of a computer system, said method steps comprising the steps of claim 1.

14. An article of manufacture comprising a computer usable medium having computer readable program code means embodied therein for causing operation of a computer system, the computer readable program code means in said article of manufacture comprising computer readable program code means for causing a computer to effect the steps of claim 2.

15. A computer program product comprising a computer usable medium having computer readable program code means embodied therein for causing operation of a computer system, the computer readable program code means in said computer program product comprising computer readable program code means for causing a computer to effect the functions of claim 10.

16. A computer program product comprising a computer usable medium having computer readable program code means embodied therein for causing operation of a computer system, the computer readable program code means in said computer program product comprising computer readable program code means for causing a computer to effect the functions of claim 11.
